(19) United States
(12) Patent Application Publication
(10) Pub. No.: US 2026/0298405 A1
(43) Pub. Date: Oct. 1, 2026

(54) FASTENING DEVICE, IN PARTICULAR FOR AN AIRCRAFT ELECTRICAL CABINET

(71) Applicant: Airbus SAS, BLAGNAC (FR)

(72) Inventors: Vincent FAUCHILLE, TOULOUSE (FR); Antoine MERCIER, TOULOUSE (FR); Benoit SENTENAC, TOULOUSE (FR); Florian MARTINEZ, TOULOUSE (FR)

(21) Appl. No.: 19/631,069

(22) Filed: Mar. 27, 2026

(30) Foreign Application Priority Data
Mar. 28, 2025 (FR) FR2503214

(51) Int. Cl. F16M 13/02; B64D 47/00

(52) U.S. Cl. CPC F16M 13/02; B64D 47/00

(57) ABSTRACT

A fastening device, in particular for an electrical cabinet of an aircraft, with a bar and at least one nut, the bar having a housing for receiving the at least one nut. The housing may be formed by an indentation cut into an outer surface of the bar. Also an electrical cabinet with such a fastening device, a bar, and an aircraft with same.

### CROSS-REFERENCES TO RELATED APPLICATIONS

This application claims the benefit of French Patent Application Number FR2503214, filed on Mar. 28, 2025, the entire disclosure of which is incorporated herein by way of reference.

### FIELD OF THE INVENTION

The present invention relates to a fastening device, in particular for an electrical cabinet of an aircraft.

### BACKGROUND OF THE INVENTION

As a result of the optimization of the space in an aircraft, the installation of the electrical cabinets may be complex. In particular, depending on the bulk of the cabinet, it may be impossible to move, in the aircraft, the cabinet provided with its fastening fittings, in which case the cabinet is first put in position and then the fittings are secured to the cabinet, for example with rivet nuts. Nevertheless, because of the reduced volume, this operation is tricky to carry out and can lead to damaging the nuts that are then inaccessible. It is then necessary to initiate a cumbersome, expensive and lengthy maintenance procedure to replace them.

It is in this context that the present invention improves the current situation.

### SUMMARY OF THE INVENTION

There is proposed a fastening device, in particular for an electrical cabinet of an aircraft, comprising a bar and at least one nut, the bar having a housing for receiving said at least one nut, wherein one end of the bar is realized by a widening with respect to a central part of the bar, so as to form a stop.

Thus, it is sufficient to slide the bar into a location provided for this purpose in the cabinet, and to screw the fittings with each nut of the bar. In the event of a problem, it is possible to simply slide the bar out of the provided location, then recover the damaged nut and replace it with a new nut, this operation being quick, easy and inexpensive. The housing makes it possible to immobilize the nut that it receives in translation.

According to another aspect, the bar has a respective housing for receiving at least two nuts.

According to another aspect, the bar has an outer surface that has cut into it a respective indentation for snap-fitting of a respective nut, forming a housing for receiving said respective nut.

According to another aspect, each respective indentation has a shape complementary to an outer surface of the nut that it is intended to receive.

According to another aspect, the bar comprises a gripping element.

According to another aspect, the gripping element is an end of the bar realized by said widening.

The invention also relates to an electrical cabinet, in particular for an aircraft, comprising a fastening device as described above and a cavity for installing said fastening device.

The invention also relates to a bar, in particular for a fastening device, comprising a housing for receiving at least one nut.

According to another aspect, the bar has an outer surface that has cut into it a respective indentation forming each housing for receiving a respective nut.

According to another aspect, each respective indentation has a shape complementary to an outer surface of the nut that it is intended to receive.

According to another aspect, the bar comprises a gripping element.

The invention also relates to an aircraft comprising a fastening device as described above and/or an electrical cabinet as described above.

### BRIEF DESCRIPTION OF THE DRAWINGS

Further features, details and advantages will become apparent upon reading the detailed description below, and analyzing the appended drawings, in which:

FIG. 1 is a schematic perspective view of a fastening device according to one embodiment of the present invention;

FIG. 2 is a schematic perspective view of a bar of the fastening device in FIG. 1;

FIG. 3 is a schematic partial perspective view of an electrical cabinet of an aircraft comprising two of the fastening devices in FIG. 1;

FIG. 4 is a perspective diagram of a detail of the cabinet in FIG. 3;

FIG. 5 is a first step of a method for installing the device in FIG. 1 in an enclosure representing the cabinet in FIG. 3;

FIG. 6 is a second step of a method for installing the device in FIG. 1 in an enclosure representing the cabinet in FIG. 3, after the first step of FIG. 5;

FIG. 7 is a third step of a method for installing the device in FIG. 1 in an enclosure representing the cabinet in FIG. 3, after the second step of FIG. 6;

FIG. 8 is a first step of a method for deinstalling the device in FIG. 1 from the enclosure representing the cabinet in FIG. 3; and,

FIG. 9 is a second step of a method for deinstalling the device in FIG. 1 from the enclosure representing the cabinet in FIG. 3, after the first step of FIG. 8.

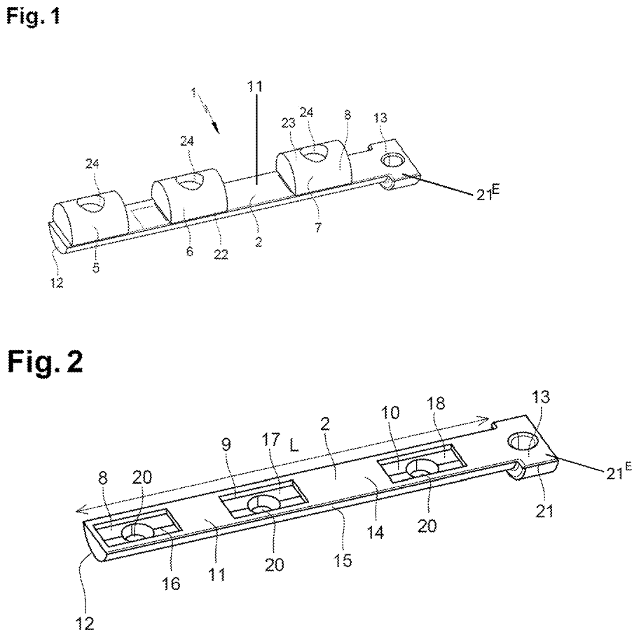

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements that, although not explicitly described or depicted here, nevertheless embody the principles of the present invention and are included in its spirit and scope.

Furthermore, for ease of understanding, the following description may describe relatively simplified implementations of the present invention. As a person skilled in the art will understand, other implementations of the present invention may be of greater complexity.

In some cases, examples of modifications of the present invention may also be presented. This is done simply as an aid to understanding, and again not to define the scope or establish the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

The invention relates to a fastening device, referenced 1 for the figures. The invention also relates to a bar 2 for the fastening device 1. The invention also relates to an electrical cabinet 3 provided with at least one fastening device 1, and to an aircraft comprising at least one electrical cabinet 3 provided with at least one fastening device 1 and/or at least one fastening device 1 equipping an accessory other than the electrical cabinet 3.

The fastening device 1 is intended to secure two elements to each other. In the embodiments illustrated, the device 1 makes it possible to fasten a fitting 4 to the cabinet 3. Of course, the invention is not limited to this application.

The fastening device 1 and the bar 2 will now be described.

The device 1 comprises the bar 2 and at least one nut. In the figures, the device 1 comprises a first nut 5, a second nut 6 and a third nut 7. The nuts 5 and 7 are called end nuts, and the second nut 6 is called central nut 6. Of course, the invention is not limited to this configuration, and the number of nuts depends on the fastening points that it is desired to ensure in the application in question, which is in this case in the example of the electrical cabinet 3.

As can be seen in the figures, the bar 2 has a respective housing 8, 9, 10 for receiving each nut 5, 6, 7.

As can also be seen in the figures, the bar 2 has a longitudinal shape comprising a central part 11 extending between a first end 12, called the internal end, and a second, external end 13. The end 12 is said to be internal because it is intended to be disposed inside the electrical cabinet 3, while the external end 13 is intended to be disposed outside the electrical cabinet 3, as will be detailed below.

The bar 2 is delimited by an outer surface of which a first portion 14 is rectangular, flat in a plane P, with the exception of the housings 8 to 10, as detailed below. Another portion 15 of the outer surface, opposite the first portion 14, is curved, for example in the form of a half-cylinder.

The outer surface has cut into it a respective indentation 16, 17, 18 allowing the snap-fitting of the respective nut 5, 6, 7, forming each receiving housing 8, 9, 10.

Each respective indentation 16, 17, 18 has a shape complementary to an outer surface of the nut 5, 6, 7 that it is intended to receive.

In the figures, the indentations 16, 17, 18 are each in the form of a rectangular cavity of which the walls perpendicular to the plane P make it possible to retain the respective nut 5, 6, 7. Thus, it is sufficient to insert the nut 5, 6, 7 into the dedicated indentation 16, 17, 18, to hold each nut in position in the bar 2. Thus, each nut is immobilized in translation by the indentation in which it is held.

As can be seen in FIG. 2, each housing 8, 9, 10 comprises a central orifice 20 for receiving a screw, as will be detailed below.

The housings 8, 9, 10 extend successively between the internal end 12 and the external end 13. In the figures, the housing 9 is closer to the housing 8 than to the housing 10. Of course, this arrangement is not limiting and the housings may be equidistant, or the housing 10 may be closer to the housing 9 than to the housing 10, depending on the appropriate locations where the fitting is to be fastened to the electrical cabinet 3.

As is apparent from the figures, the external end 13 bears a gripping element 21. In the embodiment illustrated, the gripping element 21 is formed by a widening 21^{E} of the bar 2 with respect to the central part 11. In other words, the bar 2 has the overall shape of a T. Of course, the invention is not limited to this configuration, and it is possible to envisage not a gripping element formed by the body of the bar 2 but rather a handle attached to the bar 2.

It will be noted that the widening 22 also serves to immobilize the bar in translation, giving it a precise dimension with respect to its application. When the gripping element 21 of the bar 2 comes into contact with the enclosure, for example the electrical cabinet 3, it is known that the nuts are correctly positioned opposite the orifices 28, 29 and 30. Thus, it is easy to know where to stop the translational movement of the bar during its introduction into the enclosure 3.

L denotes the length of the bar of the longitudinal part of the bar 2, excluding the gripping element 21.

As can also be seen in the figures, the nuts 5, 6, 7 comprise a flat, rectangular base 22 surmounted by a structure 23 that is curved, for example semi-cylindrical with a cross section in the form of an arc of a circle. The cavities of the indentations 16, 17, 18 have the same dimensions as the base 22, to within a clearance to make it possible to receive the base 22 of the nut and to immobilize it in translation. Each nut 5, 6, 7 is provided with a threaded hole 24. Of course, the nuts 5, 6, 7 may have shapes other than that illustrated.

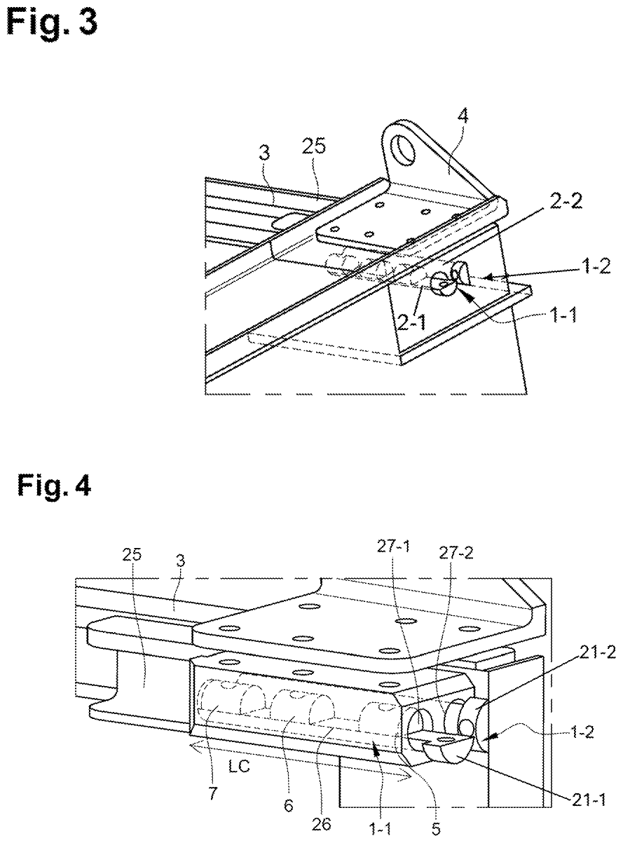

The electrical cabinet 3 will now be described, with reference to FIGS. 3 and 4.

In these figures, the electrical cabinet 3 comprises an enclosure 25 and two fastening devices, a first fastening device referenced 1-1, and a second fastening device referenced 1-2. In these figures, the two devices 1-1, 1-2 are arranged parallel to one another, the device 1-2 being rotated by 90° with respect to the device 1-1. Of course, the invention is not limited to this configuration, and the number of fastening devices, and their relative positions, may vary, depending on the fastenings required.

The enclosure 25 is provided with at least one cavity for installing each fastening device 1-1, 1-2. In FIGS. 3 and 4, one and the same cavity 26 houses both fastening devices 1-1, 1-2. Of course, the invention is not limited to this configuration, and, depending on the circumstances, a cavity can be dedicated to a single fastening device.

The cavity 26 is advantageously dimensioned so that the bars 2-1, 2-2 can be inserted as far as the gripping element 21-1, 21-2, which itself projects out of the cavity 26. In other words, a longitudinal dimension LC of the cavity 26 has a length LC less than or equal to the length L of the bar 2 (excluding the gripping element 21).

As can be seen in FIGS. 3 and 4, the cavity 26 comprises two orifices 27-1, 27-2, to let the first fastening device 1-1 and the second fastening device 1-2, respectively, pass.

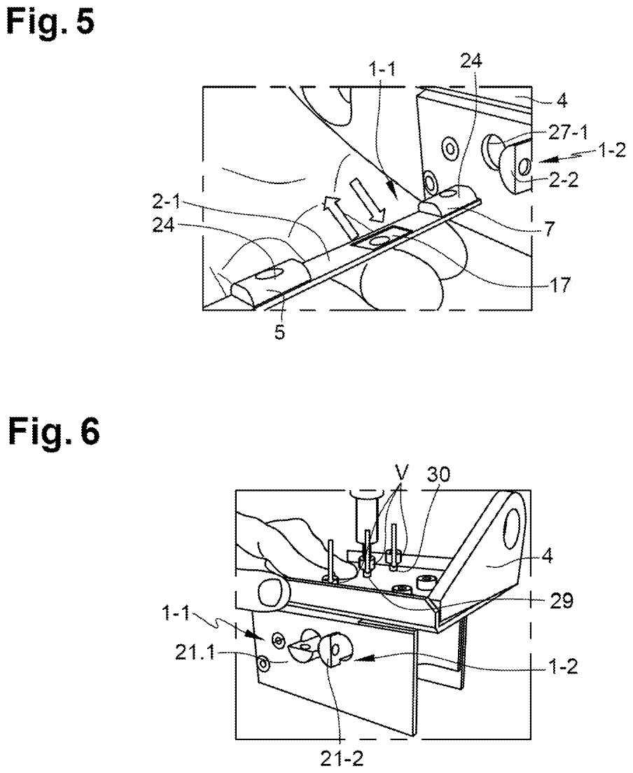

The method for securing an element E, for example the fitting 4, to the enclosure 25 will now be described, with reference to FIGS. 5, 6 and 7.

As is apparent from these figures, the device 1-1 is first of all positioned facing the orifice 27-1 (FIG. 5). It will be noted that, in FIGS. 5 to 7, the second fastening device 1-2 is already installed. In FIG. 5, only the two end nuts 5 and 7 have been snap-fitted. The central nut 6 is then inserted (step not illustrated).

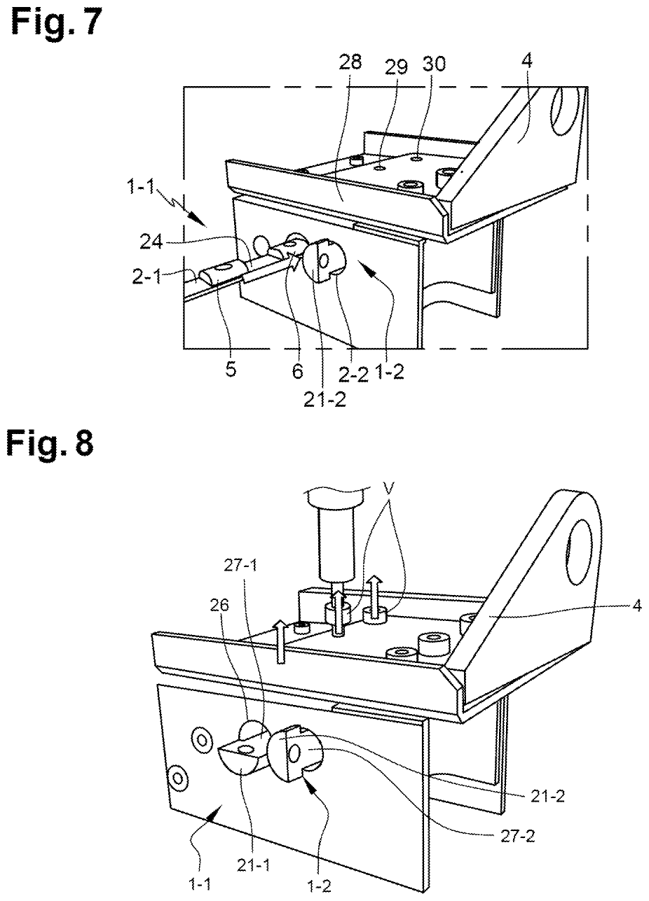

Then, the device 1-1 is moved in translation into the cavity 26 (FIG. 6), passing through the orifice 27-1. Finally, a screw V is screwed into orifices 28, 29, 30 of the fitting 4, and into each of the orifices 24 of the nuts 5, 6 and 7 (FIG. 7).

At the end of this method, the fitting 4 is fastened to the enclosure 25 by the devices 1-1 and 1-2 of which the gripping elements 21-1 and 22-2 project out of the cavity 26.

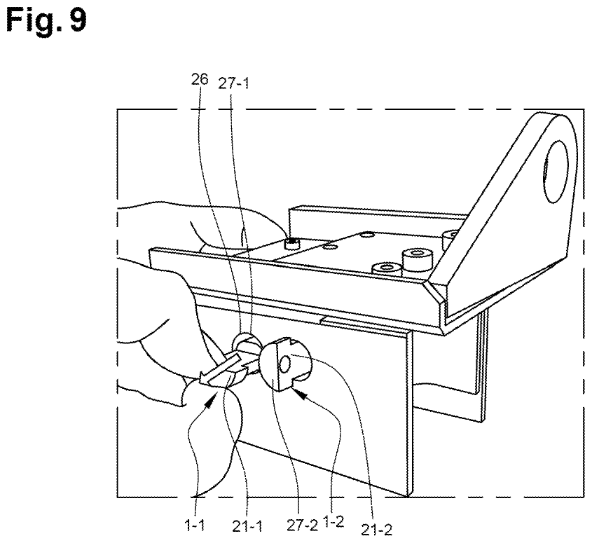

The method for disconnecting the fitting 4 from the enclosure 25 will now be described, with reference to FIGS. 8 and 9, for example to replace one or more of the nuts 5, 6 or 7.

As is apparent from these figures, the screws V are first of all unscrewed from each of the orifices 24 of the housing 8, 9 and 10, and from the orifices 28, 29, 30 of the fitting 4 (FIG. 8). Then, an operator grasps the device 1-1 by its gripping element 21-1 and slides the device 1-1 out of the cavity 26 (FIG. 9).

As is particularly apparent from FIGS. 5 to 9, the fastening devices according to the present invention are always accessible, and this makes the replacement of the nuts quick, easy and inexpensive.

Modifications and improvements to the implementations described above of the present invention may occur to a person skilled in the art.

The above description is illustrative by means of examples rather than limiting. The scope of the present invention is therefore limited solely by the scope of the claims below.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A fastening device for an electrical cabinet of an aircraft, the fastening device comprising:
a bar; and
at least one nut, the bar having a housing for receiving the at least one nut,
wherein one end of the bar comprises a widening with respect to a central part of the bar so as to form a stop.

2. The fastening device according to claim 1, wherein the bar has an outer surface that has an indentation cut into the outer surface forming the housing.

3. The fastening device according to claim 2, wherein the indentation has a shape complementary to an outer surface of the at least one nut.

4. The fastening device according to claim 1, wherein the bar further comprises a gripping element.

5. An electrical cabinet comprising:
the fastening device according to claim 1; and
a cavity for installing the fastening device.

6. A bar for a fastening device comprising:
a housing for receiving at least one nut, wherein one end of the bar comprises a widening with respect to a central part of the bar so as to form a stop.

7. The bar according to claim 6, further comprising:
an outer surface with an indentation cut into the outer surface to form the housing.

8. The bar according to claim 6, further comprising:
a gripping element.

9. An aircraft comprising:
the fastening device according to claim 1.

10. An aircraft comprising:
the electrical cabinet according to claim 5.
